(19) United States
(12) Patent Application Publication
(10) Pub. No.: US 2016/0125431 A1
(43) Pub. Date: May 5, 2016

(54) COMPETITIVE AIRLINE MARKET DATA ANALYSIS

(71) Applicant: Profusion Corp., Road Town (VG)

(72) Inventor: Harold Roy Miller, Toronto (CA)

(21) Appl. No.: 14/922,655

(22) Filed: Oct. 26, 2015

Related U.S. Application Data
(60) Provisional application No. 62/069,201, filed on Oct. 27, 2014.

(51) Int. Cl. G06Q 30/02

(52) U.S. Cl. CPC G06Q 30/0201

(57) ABSTRACT

Methods for competitive market data analysis is disclosed herein. The methods comprise receiving historical data for a plurality of air carriers. The historical data is normalized and partitioned into competitive market segments. Additionally, historical airline data related to an airline is received. The historical airline data is analyzed in view of the competitive market segments. Based on the analysis, a schedule and fleet selection of the airline can be modified.

### CROSS-REFERENCE TO RELATED APPLICATIONS

The present utility patent application is related to and claims priority benefit of the U.S. provisional application No. 62/069,201, filed on Oct. 27, 2014 under 35 U.S.C. 119(e). The disclosure of the provisional application is incorporated herein by reference.

### TECHNICAL FIELD

The present disclosure relates generally to data processing and, more particularly, to methods and systems for competitive market data analysis for an airline.

### BACKGROUND

Use of computerized systems in the travel and hospitality industries is advantageous both for customers and suppliers. Computerized systems facilitate storing and analyzing airline activities that, in turn, facilitate planning and scheduling airline operations. However, typically, an airline has access to its own information only. Therefore, an airline is limited by its historical data and unable to perform comprehensive analysis of the air transportation market. Therefore, airline data analysis may lack significant areas related to air transportation demand, load factor, revenue, and other parameters associated with flights performed by other airlines.

Furthermore, airlines often have difficulty in determining where and, in particular, when the demand for travel exists. The difficulty results from the fact that the data, on which the airlines rely, reflects destinations of historical flights and not necessarily desired for current passengers' timing. Additionally, conventional processing of the data is aimed at using actual values at any point in time rather than statistical or predictive values. This can easily be seen when, in order to capture more revenue, airlines increase gauge due to additional passengers on a particular flight. This practice can, however, be extremely detrimental to the schedule plan.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

According to one example embodiment of the disclosure, a system for competitive market data analysis is provided. The system for competitive market data analysis can include at least one processor and at least one database in communication with the at least one processor. The at least one processor may be configured to receive historical data for a plurality of air carriers from an external source, e.g. a third party. The historical data may include airline traffic, airline rates, one or more present schedules, a fleet selection, an airline fleet, a crew, an airline network, and so forth. The processor may be configured to normalize the historical data and partition the historical data into competitive market segments based on criteria received from an operator, for example, based on a flight schedule, a route, a passenger load, or a fleet. Additionally, the processor may receive historical airline data related to an airline and analyze the historical airline data in view of the competitive market segments. Based on the analysis, the processor may generate at least one modified schedule, select fleet associated with the airline, and provide them to the operator for review. Upon request from the operator, the modified schedule and fleet selection may be applied. Furthermore, based on the analysis, the processor may provide statistical data including a distribution of demand among the plurality of air carriers, performance of the airline against the demand and against at least one of the plurality of air carriers, impact of frequency on each of a plurality of markets, and so forth. Using the statistical data, the processor may determine a competitive position of the airline in relation to at least one of the plurality of air carriers, profitability of the airline based on a mean value, risk-based predictive scheduling, and so forth.

Other example embodiments of the disclosure and aspects will become apparent from the following description taken in conjunction with the following drawings.

### BRIEF DESCRIPTION OF THE DRAWINGS

Embodiments are illustrated by way of example and not limitation in the figures of the accompanying drawings, in which like references indicate similar elements.

FIG. 1 illustrates an environment within which systems and methods for competitive market data analysis can be implemented.

FIG. 2 is a block diagram showing various modules of a system for competitive market data analysis.

FIG. 3 is a process flow diagram showing a method for competitive market data analysis.

FIG. 4 is a graph illustrating air transportation demand for an airline.

FIG. 5 is a graph illustrating partitioned historical data of air transportation for air carriers.

FIG. 6 is a table showing market data of air transportation for an example destination.

FIG. 7 shows a diagrammatic representation of a computing device for a machine in the exemplary electronic form of a computer system, within which a set of instructions for causing the machine to perform any of the methodologies discussed herein can be executed.

### DETAILED DESCRIPTION

The following detailed description includes references to the accompanying drawings, which form a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

Accurate planning and scheduling of flights and selection of fleet is important for efficient management of profitability of an airline. Parameters that can be considered in airline schedule planning include operational specifics, number of passengers, load factor, competition, and so forth. For efficient planning, market data related to airline routes is desirable.

Market data can be received from a third party such as, for example, a government agency, a commercial data provider, and so forth. For example, market data related to airline traffic can be provided by airlines to the U.S. Department of Transportation (DOT). A system storing the data provided by the airlines can be referred to by the name of one of its required reports, Form 41. Form 41 may include operating or traffic statistics and financial reports (balance sheets, income statements, and the like).

A system for competitive market data analysis may retrieve historical market data from Form 41 and use the historical data to modify a schedule and/or a fleet of the airline to increase profitability. Additionally, the system for competitive market data analysis may receive data from other sources.

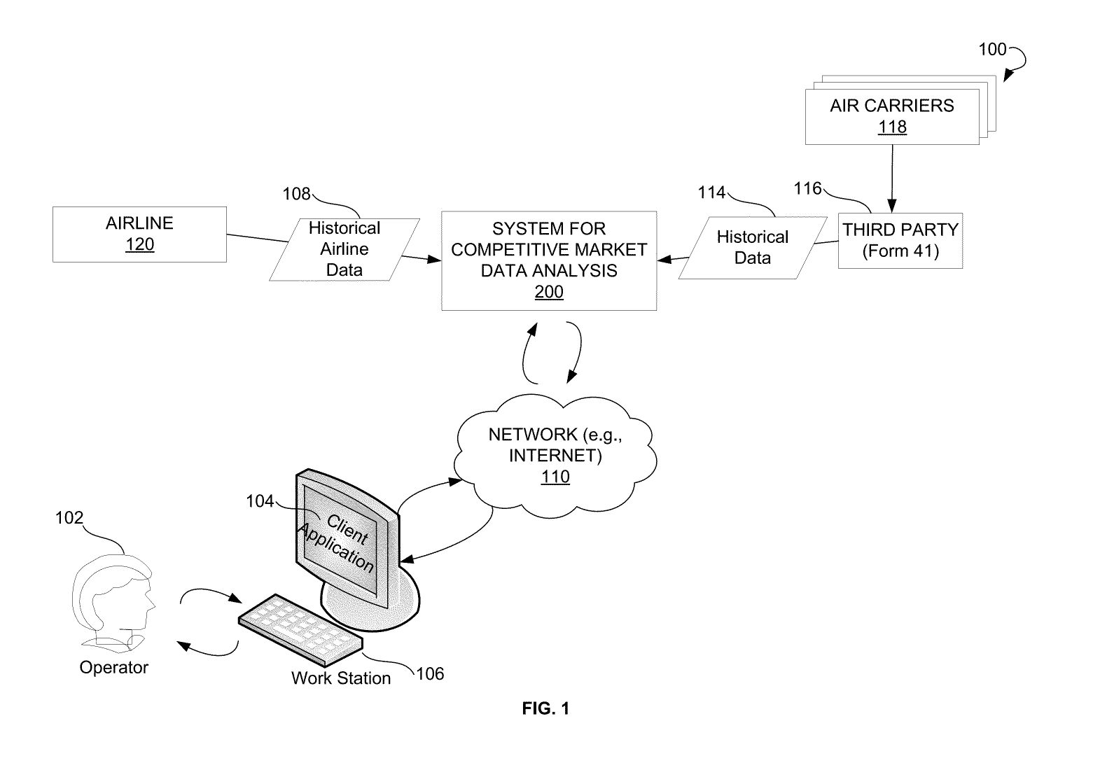

FIG. 1 illustrates an environment 100 within which the systems and methods for competitive market data analysis can be implemented. A system 200 for competitive market data analysis can include a server-based distributed application. Thus, the system 200 for competitive market data analysis may include a central component residing on a server and one or more client applications 104 for an operator 102 residing on work stations 106 and communicating with the central component via a network 110. The network 110 may include the Internet or any other network capable of communicating data between devices. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 110 can further include or interface with any one or more of an RS-232 serial connection, an IEEE-1394 (Firewire) connection, a Fiber Channel connection, an IrDA (infrared) port, a SCSI (Small Computer Systems Interface) connection, a Universal Serial Bus (USB) connection or other wired or wireless, digital or analog interface or connection, mesh or Digi® networking. One or more operators 102 may communicate with the system 200 for competitive market data analysis via the client application 104 available through the work station 106.

The central component of the system 200 for competitive market data analysis may communicate with an airline 120 to receive historical airline data 108 concerning airline traffic and rates as well as data concerning present schedules and fleet selection. The historical airline data 108 may further include, for example, details concerning the airline fleet, available crew, airline network, and so forth. Furthermore, the system 200 for competitive market data analysis may communicate with at least one third party 116 to receive historical data related to air carriers 118. The historical data 114 may include traffic statistics and financial reports of a plurality of air carriers 118; operational details concerning flights, passengers, and cargo; data concerning initial market demand; geographical data; and other data from various sources. In an example embodiment, the third party 116 can be an organization providing Form 41 that contains historical data for air carriers 118.

The system 200 for competitive market data analysis may normalize data received from various sources and process the data to analyze the air transportation market and define competitive market segments represented by the historical data 114. Based on the competitive market segments, the airline 120 can receive data indicative of competition of the airline 120 in these competitive market segments with other air carriers 118, the profitability based on the mean values, the impact of frequency, with and without other air carriers 118, in different market segments, and so forth. The system 200 for competitive market may perform data analysis in view of the competitive market segments and provide data with high information content (statistically) that includes the distribution of demand, the airline performance against this demand, against part or all of the competitive air carriers 118; the value or lack thereof of frequency in the individual markets—the ability to choose congruent operating (aircraft types) parameters to service the markets. Based on the analysis, one or more schedules modified to raise profitability of the airline 120 can be generated. In some embodiments, two or more modified schedules are compared to select one of the modified schedules based on predefined parameters (e.g., a percentage of profit increase, usage of the fleet and/or crew, and so forth). Additionally, the system 200 for competitive market may generate recommendations for the airline 120 in order to increase the profitability of airline operations. Furthermore, the system 200 for competitive market analysis can enable risk based predictive scheduling.

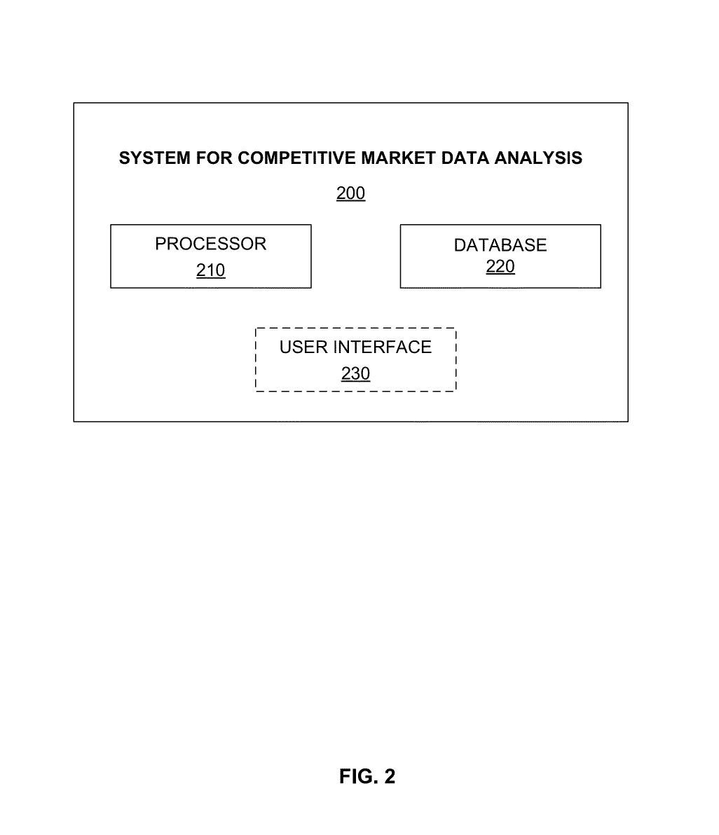

FIG. 2 is a block diagram showing various modules of the system 200 for competitive market data analysis, in accordance with certain embodiments. The system 200 for competitive market data analysis may comprise at least one processor 210 and a database 220. The processor 210 may include a programmable processor, such as a microcontroller, central processing unit (CPU), and so forth. In other embodiments, the processor 210 may include an application-specific integrated circuit (ASIC) or programmable logic array (PLA), such as a field programmable gate array (FPGA), designed to implement functions performed by the system 200. Thus, the processor 210 may receive historical data for a plurality of air carriers, normalize the historical data, and partition the historical data into competitive market segments.

Furthermore, the processor 210 may receive historical airline data related to an airline and analyze the historical airline data in view of the competitive market segments. Additionally, the processor 210 may modify, based on the analysis, the schedule and fleet selection associated with the airline. The database 220 may be configured to store the historical data, competitive market segments, and so forth. Additionally, the system 200 for competitive market data analysis may comprise an optional user interface 230 configured to enable interaction of an operator with the system 200 for competitive market data analysis.

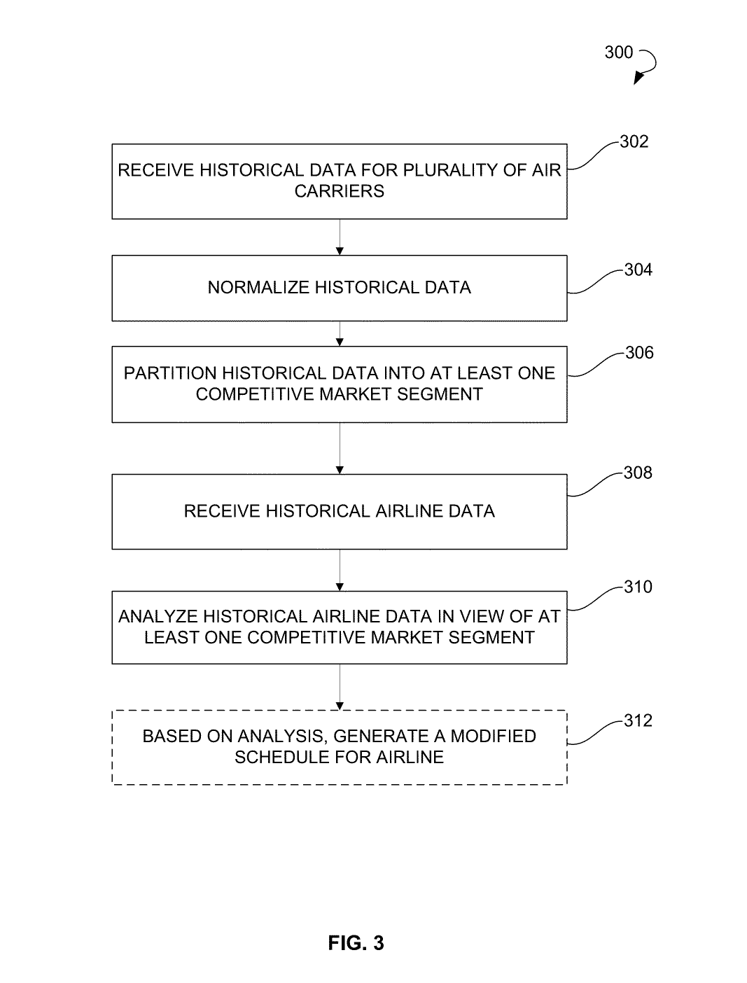

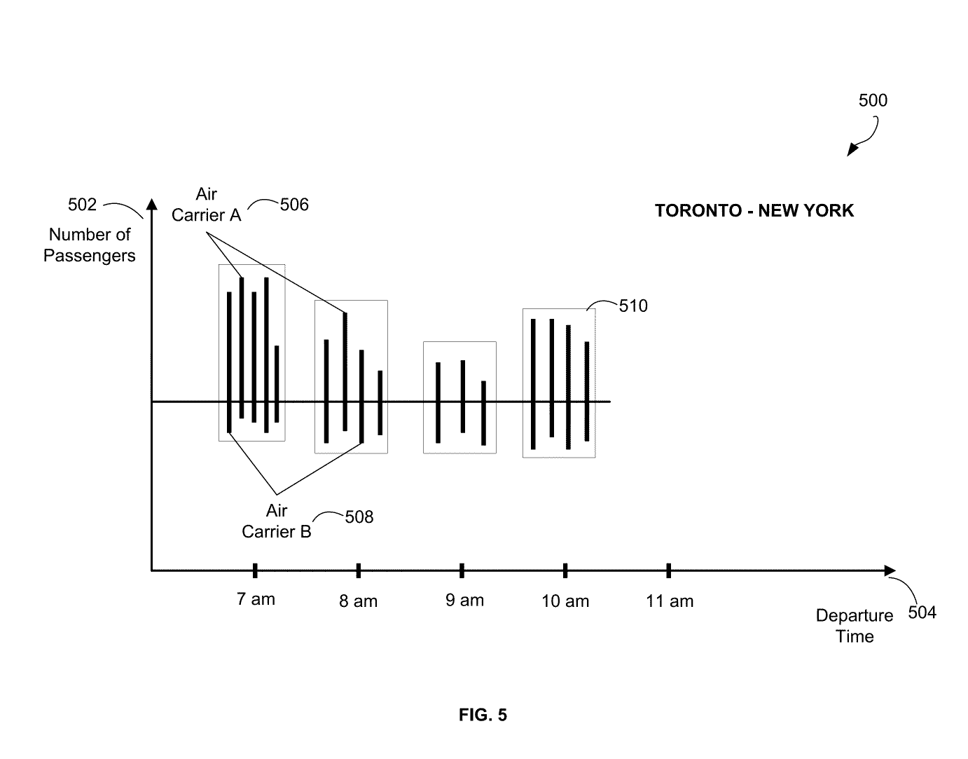

FIG. 3 is a process flow diagram showing a method 300 for competitive market data analysis within the environment 100 described above with reference to FIG. 1. The method 300 may commence with receiving historical data for a plurality of air carriers at operation 302. The historical data may include information concerning traffic and financial data of the air carriers. An example graph illustrating historical data is shown in FIG. 5 described below. Sources of the historical data may include government or industry agencies, statistical bureaus, international air transport organizations, and so forth. At operation 304, the historical data may be normalized to enable common processing of the data. For example, the historical data may be adjusted to a common scale, expressed in common values, and so forth.

The normalized historical data may be segmented into competitive market segments at operation 306. The segmentation may be based on criteria received from an operator. For example, the historical data may be partitioned into segments by flights, routes, dates, departure time, number of passengers, and so forth.

Additionally, historical airline data may be received or retrieved from a database at operation 308. The historical airline data may include a transportation schedule, fleet data, operating statistics, crew statistics, maintenance arrangements, and financial reports of the airline. The historical data may be analyzed in view of the defined competitive market segments at operation 310. The analysis may determine segments with a higher demand in comparison to other segments, segments with low competition, segments with high profitability, and so forth. In some embodiments, the analysis is performed for pre-defined itineraries. For example, the operation may specify one or more origin-and-destination pairs (e.g., Chicago-New York) for analysis. Accordingly, the historical data may be analyzed within the limits of the specified itineraries.

Furthermore, the historical airline data may be processed with respect to the analysis, and recommendations for modifying a schedule and/or fleet selection of the airline may be provided. Upon a request from an operator, a modified schedule for the airline may be generated at optional operation 312. The modified schedule may be generated to include flights in segments with low competition, segments with high profitability, and so forth to increase profitability of the airline operations. Alternatively, two or more different modified schedules may be generated for further comparison and selection of a schedule.

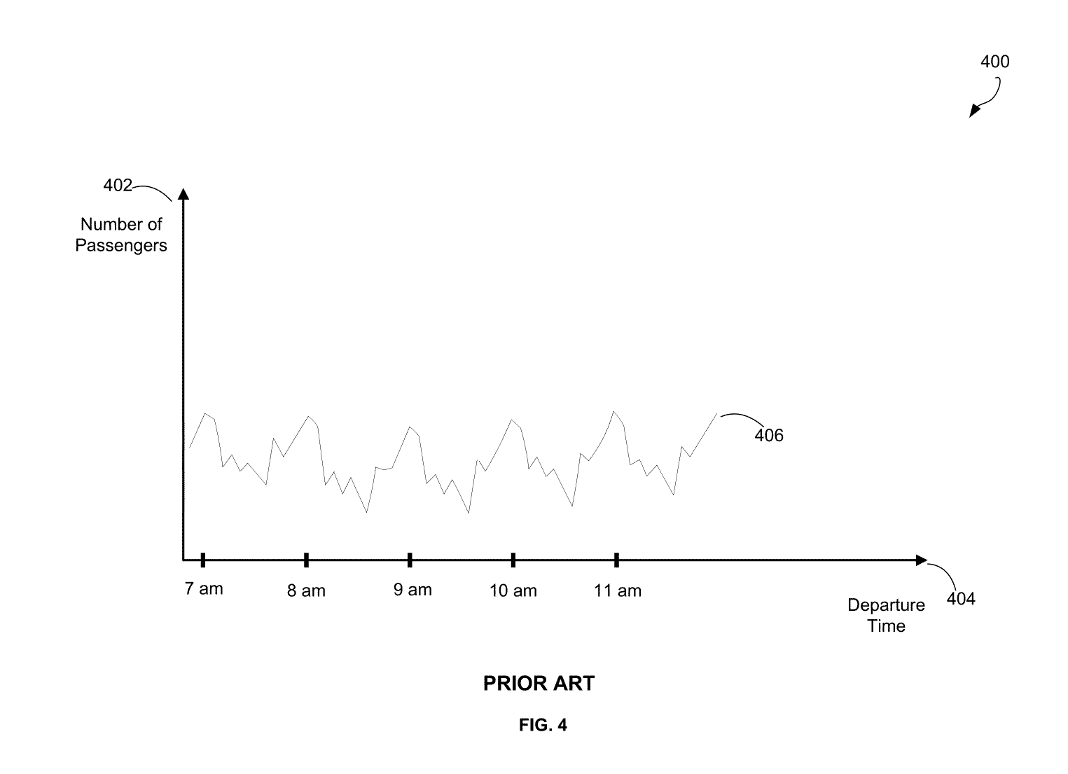

FIG. 4 shows a graph 400 illustrating air transportation demand, in accordance with certain embodiments. The graph 400 represents historical demand that is determined based on the historical airline data. A demand line 406 shows changes in number of passengers 402 in relation to time of day 404. The air transportation demand is presented for a pre-selected itinerary. The data concerning the demand can be used by the airline to approximate capacity and create a schedule, select fleet, find a crew, schedule maintenance, and so forth. However, the data used by the airline may be insufficient for a comprehensive analysis since the data only covers the time of the actual flight. For example, if there was a flight at 8 am, the airline has data for the 8 am flight, but no data concerning the demand for a 9 am flight.

FIG. 5 shows a graph 500 illustrating the number of passengers transported by each air carrier 506, in accordance with certain embodiments. The graph 500 represents historical data for one or more air carriers, for example, air carrier 506 and air carrier 508. The historical data can be received from a third party. According to the historical data, the number of passengers 502 transported by air carrier 506, air carrier 508, and other air carriers for an example itinerary, e.g., from Toronto to New York, is presented in relation to the departure time 504. The presented historical data is partitioned into market segments 510 by the departure time 504. The partitioning by the departure time 504 is provided as an example only, and in other embodiments, partitioning can be made based on other parameters, for example, a route, a passenger load, a fleet, and so forth.

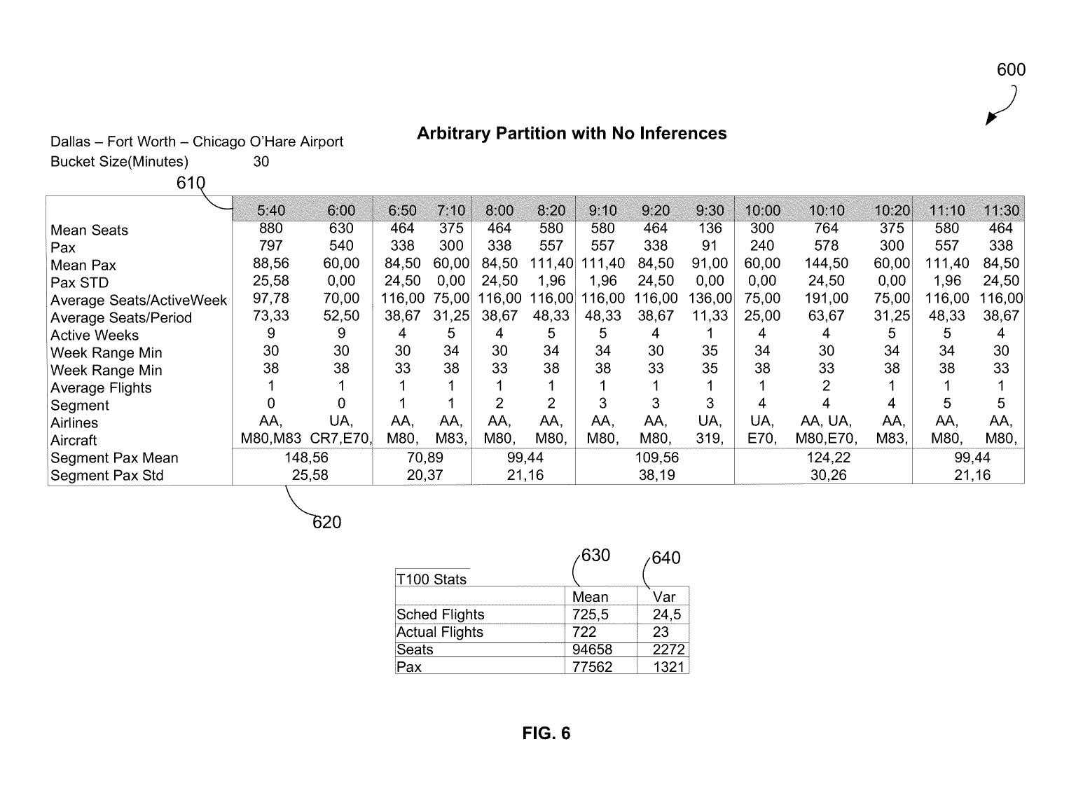

The historical data for each of the market segments 510 may be analyzed and a market share of the airline versus other air carriers can be determined. Additionally, the load factor of the airline may be determined as a result of the analysis. Therefore, upon receipt of data concerning actual demand, the system 200 for competitive market data analysis may determine a position of a particular air carrier with regards to the demand. Additionally, the frequency to load factor may be determined based on the historical data. The system 200 for competitive market data analysis can compare the market share and the load factor against those of the competition, and based on the comparison, provide recommendations to the airline to efficiently modify the schedule and fleet selection. Example representation of market data is described in more detail with reference to FIG. 6 below.

FIG. 6 illustrates market data 600 for an example destination, in accordance with some example embodiments. The market data 600 illustrates demand in relation to time based on historical data of the air carriers operating at the example destination (Dallas-Fort Worth Airport to Chicago O'Hare Airport). The data is partitioned into competitive market segments 620 by departure time 610, and each competitive market segment 620 corresponds to, for example, 30 minutes.

The information received from the system 200 for competitive market data analysis can be used for statistical purposes. The data collected by the system 200 represents flights performed over a considerable time, so the system 200 can determine mean 630 and variance 640 of the demand in a competitive market segment 620. This data may be utilized by an airline to decide on selection of the aircraft based on the number of passengers and so forth. In some cases, using a smaller aircraft in all competitive market segments 620 can generate a higher profit than using a bigger aircraft.

Generally, the demand depends on desired destinations of passengers. Analyzing historical data of all of the airline flights allows determining historical demand (where the demand was based on the historical data). For example, with respect to the Dallas to Chicago route, the demand may be high for early morning flights with some low frequency spread over the morning into midafternoon. Delivering an aircraft is a difficult task, so for ease of scheduling, details of the aircraft and desired route can be provided. Based on the provided data, the airline market demand and market share at a desired location can be determined. These parameters may justify using a smaller aircraft throughout the day.

The system 200 for competitive market data analysis can provide an airline with statistical data, such as the airline competition areas, historical market fluctuations, desired flight frequencies, statistical variance from day to day and week to week within the market, and so forth. The statistical data may be used for efficient schedule planning, in order to redistribute market share of the airline by using a different market strategy. In some embodiments, risk based business modeling can be carried out.

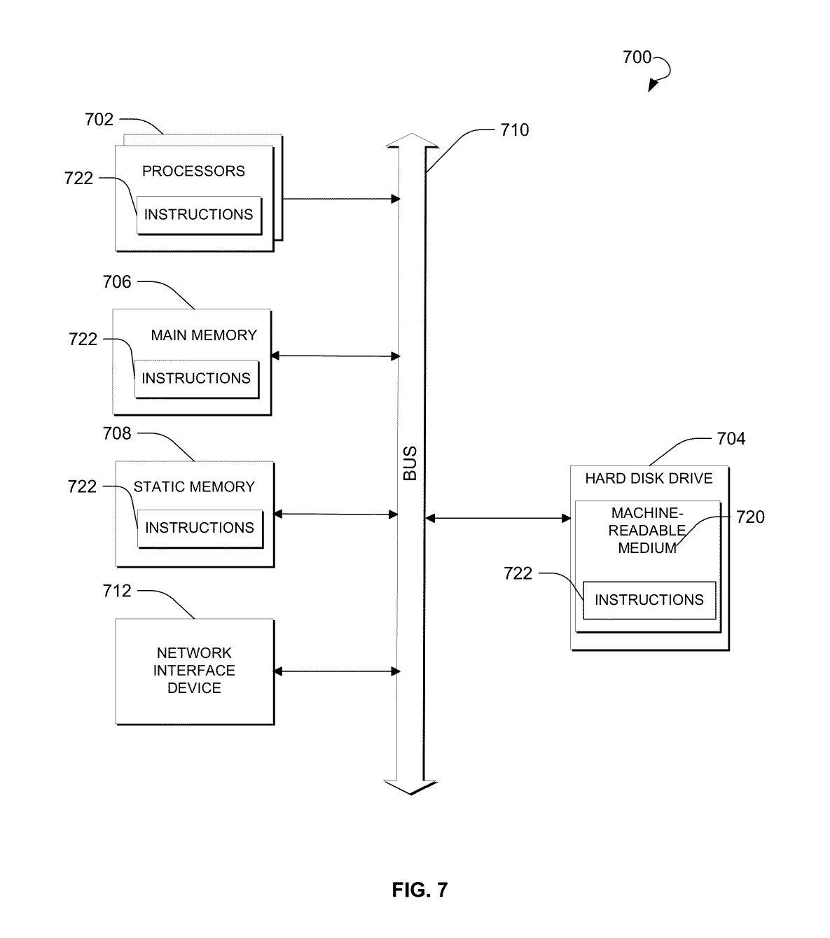

FIG. 7 shows a diagrammatic representation of a machine in the example electronic form of a computer system 700, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a PC, a tablet PC, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor or multiple processors 702 (e.g., a central processing unit (CPU), a graphics processing unit, or both), a main memory 706 and a static memory 708, which communicate with each other via a bus 710. The computer system 700 may further include a hard disk drive 704 and a network interface device 712.

The hard disk drive 704 includes a non-transitory processor-readable medium 720, on which is stored one or more sets of instructions and data structures (e.g., instructions 722) embodying or utilized by any one or more of the methodologies or functions described herein. The instructions 722 may also reside, completely or at least partially, within the main memory 706 and/or within the processors 702 during execution thereof by the computer system 700. The main memory 706 and the processors 702 may also constitute machine-readable media.

The instructions 722 may further be transmitted or received over a network via the network interface device 712 utilizing any one of a number of well-known transfer protocols (e.g., Hyper Text Transfer Protocol).

In some embodiments, the computer system 700 may be implemented as a cloud-based computing environment, such as a virtual machine operating within a computing cloud. In other embodiments, the computer system 700 may itself include a cloud-based computing environment, where the functionalities of the computer system 700 are executed in a distributed fashion. Thus, the computer system 700, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners, or such systems may be accessible to outside users who deploy applications within the computing infrastructure to obtain the benefit of large computational or storage resources.

The cloud may be formed, for example, by a network of web servers that comprise a plurality of computing devices, with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system Random Access Memory (RAM). Transmission media include coaxial cables, copper wire, and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk, any other optical medium, any other physical medium with patterns of marks or holes, a RAM, a PROM, an EPROM, an EEPROM, a FLASHEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider).

The corresponding structures, materials, acts, and equivalents of all means or steps plus function elements in the claims below are intended to include any structure, material, or act for performing the function in combination with other claimed elements as specifically claimed. The description of the present technology has been presented for purposes of illustration and description, but is not intended to be exhaustive or limited to the disclosure. Many modifications and variations will be apparent to those of ordinary skill in the art without departing from the scope and spirit of the disclosure. Exemplary embodiments were chosen and described in order to best explain the principles of the present technology and its practical application, and to enable others of ordinary skill in the art to understand the disclosure for various embodiments with various modifications as are suited to the particular use contemplated.

Aspects of the present technology are described above with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Thus, computer-implemented methods and systems for competitive market data analysis are described. Although embodiments have been described with reference to specific exemplary embodiments, it will be evident that various modifications and changes can be made to these exemplary embodiments without departing from the broader spirit and scope of the present application. Accordingly, the specification and drawings are to be regarded in an illustrative rather than a restrictive sense.

What is claimed is:

1. A method for competitive market data analysis, the method comprising:
receiving, by a processor, historical data for a plurality of air carriers;
normalizing, by the processor, the historical data;
partitioning, by the processor, the historical data into competitive market segments;
receiving, by the processor, historical airline data related to an airline; and
analyzing, by the processor, the historical airline data in view of the competitive market segments.

2. The method of claim 1, further comprising, based on the analysis, modifying at least one schedule and fleet selection associated with the airline.

3. The method of claim 1, wherein the partitioning of the competitive market segments is based on at least one of the following: a flight schedule, a route, a passenger load, and a fleet.

4. The method of claim 1, wherein the partitioning of the competitive market segments is based on criteria received from an operator.

5. The method of claim 1, further comprising, based on the analysis, providing statistical data including at least one of the following: a distribution of demand among the plurality of air carriers, a performance of the airline against the demand and against at least one of the plurality of air carriers, and an impact of frequency on each of a plurality of markets.

6. The method of claim 5, further comprising determining using the statistical data including at least one of the following: a competitive position of the airline in relation to at least one of the plurality of air carriers, profitability of the airline based on a mean value, and risk-based predictive scheduling.

7. The method of claim 1, wherein the analysis is performed for one or more predefined itineraries.

8. The method of claim 1, further comprising:
based on the analysis, generating two or more modified schedules associated with the airline;
comparing the two or more modified schedules; and
selecting, based on the comparison, one of the two or more modified schedules based on predefined parameters.

9. The method of claim 1, further comprising:
based on the analysis, determining at least one competitive market segment with a higher demand in comparison to other competitive market segments, at least one competitive market segment with a low competition, and at least one competitive market segment with a high profitability.

10. A system for competitive market data analysis, the system comprising:
at least one processor configured to:
receive historical data for a plurality of air carriers;
normalize the historical data;
partition the historical data into competitive market segments;
receive historical airline data related to an airline; and
analyze the historical airline data in view of the competitive market segments; and
at least one database in communication with the at least one processor, the at least one database configured to store at least the historical data and the competitive market segments.

11. The system of claim 10, wherein the processor is further configured to modify, based on the analysis, at least one schedule and fleet selection associated with the airline.

12. The system of claim 10, wherein the partitioning of the competitive market segments is based on at least one of a flight schedule, a route, a passenger load, and a fleet.

13. The system of claim 10, wherein the partitioning of the competitive market segments is based on criteria received from an operator.

14. The system of claim 10, wherein the processor is further configured to provide statistical data based on the analysis, the statistical data including at least one of the following: a distribution of demand among the plurality of air carriers, a performance of the airline against the demand and against at least one of the plurality of air carriers, and an impact of frequency in each of a plurality of markets.

15. The system of claim 14, wherein the processor is further configured to determine using the statistical data, at least one of the following: a competitive position of the airline in relation to at least one of the plurality of air carriers, profitability of the airline based on a mean value, and risk-based predictive scheduling.

16. The system of claim 10, wherein the analysis is performed for one or more predefined itineraries.

17. The system of claim 10, wherein the processor is further configured to:
generate, based on the analysis, two or more modified schedules associated with the airline;
compare the two or more modified schedules; and
select, based on the comparison, one of the two or more modified schedules based on predefined parameters.

18. The system of claim 10, wherein the processor is further configured to determine, based on the analysis, at least one competitive market segment with a higher demand in comparison to other competitive market segments, at least one competitive market segment with a low competition, and at least one competitive market segment with a high profitability.

19. The system of claim 10, wherein the historical data includes data associated with airline traffic, airline rates, one or more present schedules, a fleet selection, an airline fleet, a crew, and an airline network.

20. A non-transitory processor-readable medium having instructions stored thereon, which when executed by one or more processors, cause the one or more processors to implement a method for competitive market data analysis, the method comprising:
receive historical data for a plurality of air carriers;
normalize the historical data;
partition the historical data into competitive market segments;
receive historical airline data related to an airline; and
analyze the historical airline data in view of the competitive market segments.
